(19) United States
(12) Patent Application Publication
(10) Pub. No.: US 2009/0151746 A1
(43) Pub. Date: Jun. 18, 2009

(54) Cleaning apparatus for dental flossing

(76) Inventors: Deborah (Debbie) Wright, Kalama, WA (US); David Allen Wright, Kalama, WA (US)

Correspondence Address: Debbie L. Wright, P.O.Box 1404, Kalama, WA, 98625, US

(21) Appl. No.: 12/152,871

(22) Filed: May 19, 2008

Related U.S. Application Data
(63) Continuation-in-part of application No. 11/958,529, filed on Dec. 18, 2007.

(51) Int. Cl. A61C 15/00; A61C 15/04; A46B 15/00

(52) U.S. Cl. 132/323; 132/328; 132/329; 15/106

(57) ABSTRACT

A cleaning apparatus capable of being used in dental procedures is disclosed. The cleaning apparatus comprises an elongated handle and a cleaning member. The elongated handle comprises a first end portion and second end portion with spring tension attached to handle. The detachable dental floss has a proximal end and distil end. The proximal end of dental floss is attached to spring tension and the destil end of the dental floss with the brush is engaged to the pistil end of handle in a way that allows the dental floss to move freely with the spring tension.

### FIELD OF THE INVENTION

The present invention relates generally to dental appliances, and, more particularly, to a cleaning apparatus used in dental procedures, such as flossing.

### BACKGROUND OF THE INVENTION

Cleaning apparatuses such as dental floss are used to remove food and dental plaque from teeth of a person. The dental floss is ordinarily made of soft materials, such as a thin nylon filament or a plastic ribbon. During dental procedures, such as flossing, the dental floss is smoothly inserted between the teeth for scrapping along the teeth sides close to gums. The floss is smoothly wrapped around a tooth and then moved away from the gum line for removing the food and plaque from the teeth. The dental floss can also be used to clean a front or a back side of the tooth.

Presently existing dental flosses used for removing food and the dental plaque from the teeth have numerous limitations. For example, existing dental flosses are difficult to operate when used on persons wearing orthodontic braces over the teeth. Further, these dental flosses are unable to provide and alter a tension in the flosses in order to suit the teeth structure of the different individuals. Further, the existing dental flosses generally require use of fingers to hold the floss in the mouth while flossing.

Therefore, based on the foregoing, there is need for a cleaning apparatus capable of being used in dental procedures, such as flossing, which facilitates a proper removal of food and dental plaque from teeth, generally and also in cases of persons wearing orthodontic braces over teeth. Further, the cleaning apparatus should also be capable of providing and altering proper tension of the floss. Further, the cleaning apparatus should also be capable of avoiding the insertion of fingers fully inside the mouth during flossing procedure.

### SUMMARY OF THE INVENTION

In view of the foregoing disadvantages inherent in the prior art, the general purpose of the present invention is to provide a cleaning apparatus capable of being used in dental procedures, like flossing, configured to include all the advantages of the prior art, and to overcome the drawbacks inherent therein.

Therefore, an object of the present invention is to provide a cleaning apparatus, which is capable of removing food and dental plaque from teeth of a person with orthodontics as well as without.

Another object of the present invention is to provide a cleaning apparatus, in which minimizes the use of fingers in the mouth while flossing.

Yet another object of the present invention is to provide a cleaning apparatus, in which tension of the dental floss can be adjusted based on the structure of teeth of different individuals.

Therefore, in one aspect, the present invention provides a cleaning apparatus capable of being used in dental procedures, such as flossing. The cleaning apparatus comprises an elongated handle and a cleaning member. The elongated handle has a first end portion and a second end portion. The cleaning member comprises dental floss and a brush or pick, (approximately ⅝ of an inch long. The floss has a proximal end portion and a distal end portion. The proximal end portion of dental floss is removable coupled to a connecting point between the first end portion of the elongated handle and the second end portion of elongated handle. The distal end portion of dental floss is engaged to the second end portion of the elongated handle. The brush or pick is attached to the dental floss which is attached to the distal end portion of the dental floss.

These together with other aspects of the present invention, along with the various features of novelty that characterizes the present invention, are pointed out with particularity in the claims annexed hereto and from a part of this present invention. For a better understanding of the present invention, it's operating advantages, and specific objects attained by it's uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conduction with the accompanying drawings, wherein like elements are identified with like symbols, and in which:

FIG. 1 is a perspective view of a cleaning apparatus, according to an exemplary of the present invention;

FIG. 2 is a perspective view of a cleaning apparatus, according to another exemplary embodiment of the present invention; and

FIG. 3 is a schematic perspective view depicting an application of a cleaning apparatus in removing food and dental plaque from teeth of a person wearing orthodontic braces, according to an exemplary embodiment of the present invention.

Like reference numerals refer to like parts throughout the description of several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular cleaning apparatus, as shown and described. It is understood that various omissions and substitutions of equivalents are contemplated as circumstances may suggest or render expedient, but these are intended to cover the application or implementation without departing from the spirit or scope of the claims of the present invention.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

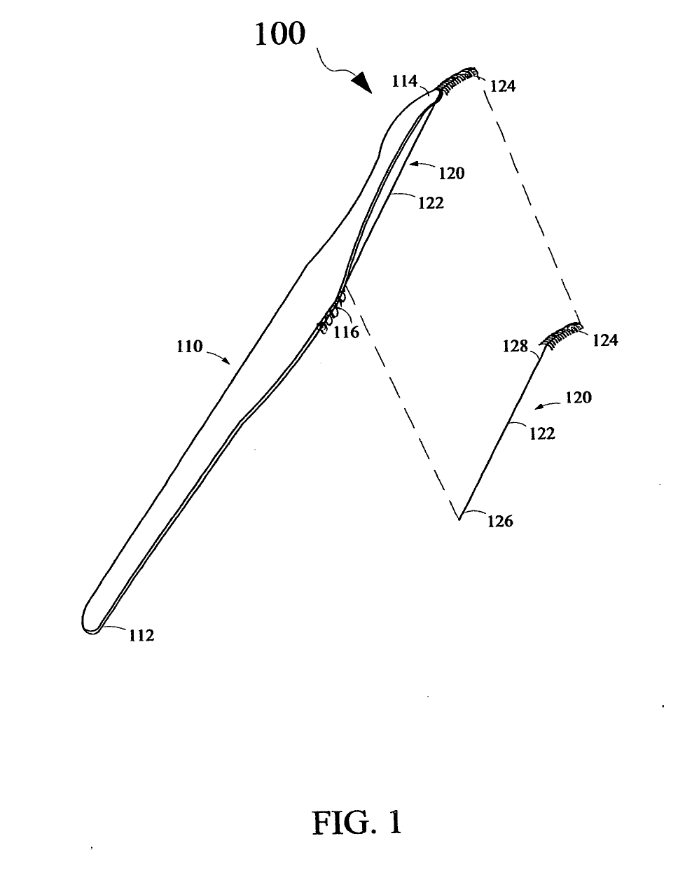

Referring to FIG. 1, a cleaning apparatus 100 capable of being used in dental procedures, such as flossing, is shown. FIG. 1 is a perspective view of the cleaning apparatus 100, according to an exemplary embodiment of the present invention. The cleaning apparatus 100 comprises an elongated handle 110 and a cleaning member 120. The elongated handle 110 may be made of light weight and flexible materials including, but not limited to, rubber, and plastic. Preferably, the elongated handle 110 may be made of non-stick rubber. The elongated handle 110 has a first end portion 112 and a second end portion 114. The elongated handle 110 may have variable width along a length of the elongated handle 110 to provide a firm grip for a user. Additionally, the elongated handle 110 may comprise a gripping element (not shown), which is coupled to the first end portion 112 of the elongated handle 110 and covers a portion of the elongated handle 110 to provide extra grip to the user.

The cleaning member 120 comprises of dental floss 122 and a brush 124. The dental floss 122 of the cleaning member 120 is used for cleaning areas between the teeth. As shown in FIG. 1, the dental floss member 122 has a proximal end portion 126 and a distal end portion 128. The proximal end portion 126 of the dental floss 122 is removably coupled to a connecting point 116 on the elongated handle 110. More specifically, the connecting point 116 lies between the first end portion 112 and the second end portion 114 of the elongated handle 110. The type of connecting point, spring 116, but not limited to, may be chosen based on the desired tension desired on dental floss 122. The distal end portion 128 of the dental floss 122 is slidably engaged to the second end portion 114 of the elongated handle 110.

In one embodiment of the present invention, the second end portion 114 of the elongated handle 110 may comprise a mechanism, such as an opening, slip or spiral (not shown) on the second end portion 114 that facilitates the dental floss 122 to slide along surface of the elongated handle 110. More specifically, the dental floss 122 is configured in a manner such that 122 may be quickly disconnected from the second end portion 114 of the elongated handle 110 by applying a quick, easy motion. The dental floss 122, which is pulled outside of the elongated handle through the through opening, is used for the cleaning purposes during the flossing procedure.

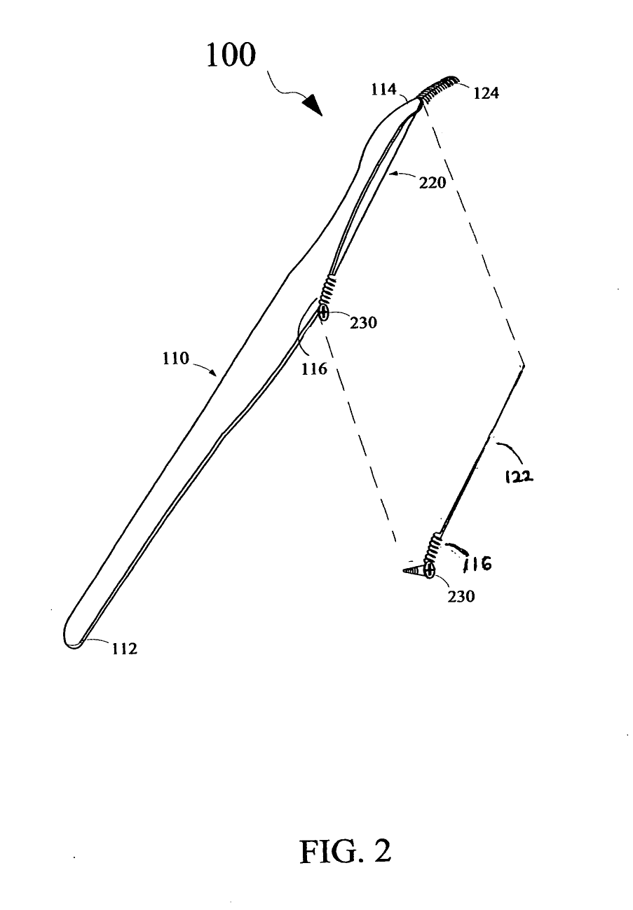

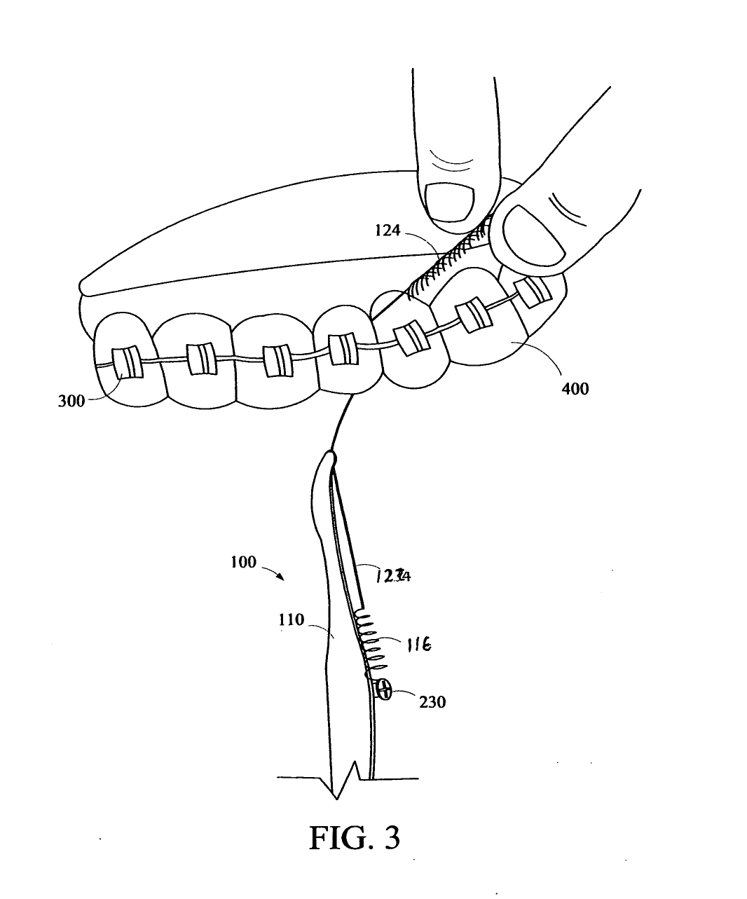

The brush 124, (not limited to) to the distal end portion 128 of the dental floss 122. The brush is attached with dental floss 122 to provide additional cleaning in areas between teeth. The use of the brush 124 is further described in conjunction with FIG. 3. In one embodiment of the present invention, the dental floss 122 proximal 126. Easily attached to expansion mechanism, (in this case spring but not limited to) 116 with permanent location on handle 110. During the flossing procedure, an overall length of dental floss 122 may be adjusted by expanding/adjusting/compressing, (not limited to spring, rubber or dial mechanism) the expansion mechanism based on the comfort or needs of the dentist/person and the person who is undergoing the flossing treatment. An xemplary arrangement of this embodiment is described in detail in conjunction with FIG. 2. However, in another embodiment of the present invention, the dental floss 122 is attached to a spring for automatic self adjusting in FIG. 1. The dental floss 122 easily attached to spring allows the fastest Ortho dental flossing with no adjusting restrictions but easily controlled by application of a small force by fingers of the hand.

Referring now to FIG. 1, another embodiment of the cleaning apparatus 100 is shown. Herein, an exemplary expansion mechanism 116 of the cleaning apparatus 100 is represented, which includes a connected floss 122 for performing the flossing between the teeth. The expansion mechanism 116, which may be expanded/compressed in order to adjust the tension needed for the proper flossing.

Herein, as represented in FIG. 2, the cleaning apparatus 100 comprises the elongated handle 110 and a cleaning member 220 and the brush 124 at the distal of handle at 114. The adjusting mechanism 116 as permanent stracture to handle 110, allowing dental floss 220 to move freely. as tension is applied by fingers pulling motion at distal of brush 124. Adjusting mechanism, spring 116 in FIG. 2 has been permanently applied to handle 110 by small screw 230. Screw 230 can be converted to a tension adjuster with small modifications, (not shown in picture)

The application of the cleaning apparatus 100 in the flossing procedure of teeth of a person shown in FIG. 3. In FIG. 3, teeth 400 of the person, orthodontic braces 300 over the teeth 400 and the cleaning apparatus 100 is shown. The cleaning apparatus 100 is used for the flossing the teeth 400 and the orthodontic braces 300. The cleaning apparatus 100 is capable of removing food particles and dental plaque from the teeth 400 and the orthodontic braces 300 of the person.

The brush 124 of the cleaning apparatus 100 may be inserted between wires of the orthodontic braces 300 and the teeth 400 of the person. Further, the brush 124 of the cleaning apparatus 100 is clutched with fingers for pulling the dental floss 122 outward from the elongated handle 110 of the cleaning apparatus 100. By keeping proper tension on the dental floss 122 it can be gently inserted between the teeth 400 of the person for flossing. After the completion of the flossing procedure, the dental floss 122, which is between the teeth 400 is removed. During the flossing procedure, the brush 124 may assist the dental floss 122 to reach in different areas between the teeth 400. Further, the brush 124 may also act as an additional cleaning element.

The foregoing descriptions of specific embodiments of the present invention having been presented for the purpose of illustration and description. They are not intended to be exhaustive or to limit the present invention to the precise forms disclosed, and obviously many modifications and variations are possible in the light of the above teaching. The embodiments were chosen and described in order to best explain the principles of the present invention and it's practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the claims of the present invention.

What is claimed is:

1. A cleaning apparatus capable of being used in dental procedures, comprising:
an elongated handle having a first end portion and a second end portion; a cleaning member comprising,
dental floss having a proximal end and distal end portion, wherein is removable coupled to tension between the first end portion and the elongated handle and the second end portion of elongated handle, wherein the distill end portion of the dental floss is slidably engaged to the second end portion of the elongated handle and
a brush attached to the distal end portion of the dental floss.

2. The cleaning apparatus of claim 1, wherein the cleaning apparatus comprises:
a spring mechanism coupled to the elongated handle, a floss and the brush are coupled at the distill end portion of the spring.

3. The cleaning apparatus of claim 1. wherein the elongated handle comprise a gripping element coupled to the first end portion of the elongated handle.
